(19) United States
(12) Patent Application Publication
(10) Pub. No.: US 2017/0347536 A1
(43) Pub. Date: Dec. 7, 2017

(54) Plant Support Device

(71) Applicant: Gale Williams, Corpus Christi, TX (US)

(72) Inventor: Gale Williams, Corpus Christi, TX (US)

(21) Appl. No.: 15/175,895

(22) Filed: Jun. 7, 2016

(51) Int. Cl. A01G 9/12

(52) U.S. Cl. CPC A01G 9/128; A01G 9/122

(57) ABSTRACT

A plant support device for providing support to the stem of a plant includes a rod that is configured to insert vertically into a planting bed. A positioner is slidably couplable to the rod. A holder, which comprises a strap, is coupled to the positioner. The strap is variably couplable to the holder to form a loop. The rod is configured to insert vertically into the planting bed proximate to a stem of a plant requiring support. The positioner is variably couplable to the rod such that the positioner is positionable at a required height relative to the stem. The strap is configured to position around the stem of the plant and to couple to the holder to form the loop. The loop extends from the holder around the stem of the plant to support the plant.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to plant support devices and more particularly pertains to a new plant support device for providing support to the stem of a plant.

### BRIEF SUMMARY OF THE INVENTION

An embodiment of the disclosure meets the needs presented above by generally comprising a rod that is configured to insert vertically into a planting bed. A positioner is slidably couplable to the rod. A holder, which comprises a strap, is coupled to the positioner. The strap is variably couplable to the holder to form a loop. The rod is configured to insert vertically into the planting bed proximate to a stem of a plant requiring support. The positioner is variably couplable to the rod such that the positioner is positionable at a required height relative to the stem. The strap is configured to position around the stem of the plant and to couple to the holder to form the loop. The loop extends from the holder around the stem of the plant to support the plant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a plant support device according to an embodiment of the disclosure.

FIG. 2 is a bottom view of an embodiment of the disclosure.

FIG. 3 is a front view of an embodiment of the disclosure.

FIG. 4 is an in-use view of an embodiment of the disclosure.

### DETAILED DESCRIPTION OF THE INVENTION

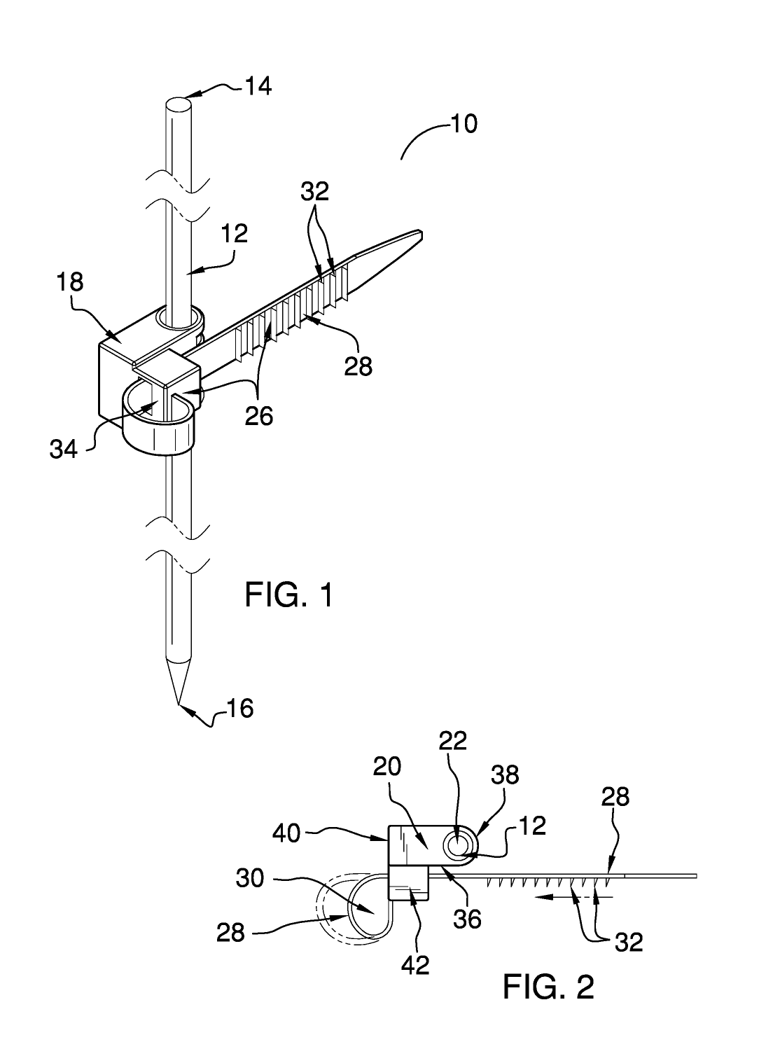

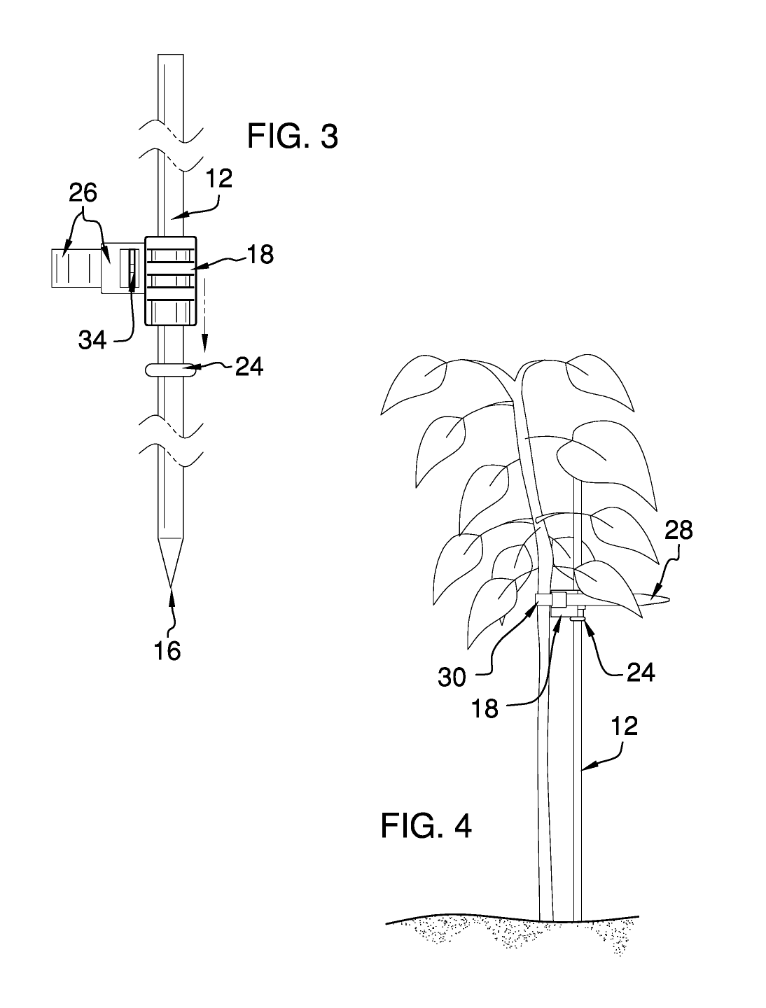

With reference now to the drawings, and in particular to FIGS. 1 through 4 thereof, a new plant support device embodying the principles and concepts of an embodiment of the disclosure and generally designated by the reference numeral 10 will be described.

As best illustrated in FIGS. 1 through 4, the plant support device 10 generally comprises a rod 12 that is configured to insert vertically into a planting bed. The rod 12 is circular when viewed longitudinally. In one embodiment, the rod 12 comprises aluminum. In another embodiment, the rod 12 comprises plastic. The rod 12 has a top end 14 and a bottom end 16. The bottom end 16 is pointed, such that the bottom end 16 is configured to insert vertically into the planting bed.

A positioner 18 is slidably couplable to the rod 12 between the top end 14 and the bottom end 16. The positioner 18 is positionable at a required height relative to a stem of a plant positioned proximate to the rod 12 in the planting bed. In one embodiment, the positioner 18 comprises a block 20. The block 20 is substantially rectangularly box shaped. The block 20 is resilient. The block 20 comprises rubber. A channel 22 is positioned through the block 20 proximate to a first end 38 of the block 20. The channel 22 is complementary to the rod 12, such that the rod 12 is insertable into the channel 22.

A gasket 24 is slidably couplable to the rod 12 between the positioner 18 and the bottom end 16. The gasket 24 is positioned on the rod 12 to retain the positioner 18 at the required height relative to the stem of the plant. The gasket 24 is resilient. The gasket 24 comprises rubber.

A holder 26, which comprises a strap 28, is coupled to the positioner 18. The strap 28 is variably couplable to the holder 26 to form a loop 30. The strap 28 is configured to position around the stem of the plant and to couple to the holder 26 to form the loop 30. The loop 30 extends from the holder 26 around the stem of the plant to support the plant. In one embodiment, the strap 28 comprising a rack gear 32. The strap 28 may comprise nylon. The strap 28 may comprise stainless steel.

A coupler 34 is coupled to the block 20. The coupler 34 is positioned on a side 36 of the block 20 proximate to a second end 40 of the block 20. The coupler 34 is couplable to the strap 28 to form the loop 30. In one embodiment the coupler 34 comprises a ratchet box 42. The ratchet box 42 is positioned to gearedly couple to the rack gear 32 of the strap 28 to form the loop 30. The present invention also anticipates a tab coupled to the ratchet box 42 to release the strap 28 from the ratchet box 42. Releasing the strap 28 allows the loop 30 to be opened, such that the device 10 can be reused.

In use, the rod 12 is configured to insert vertically into the planting bed proximate to a stem of a plant requiring support. The positioner 18 is variably couplable to the rod 12 such that the positioner 18 is positionable at a required height relative to the stem. The strap 28 is configured to position around the stem of the plant and to couple to the holder 26 to form the loop 30. The loop 30 extends from the holder 26 around the stem of the plant to support the plant.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant support device comprising:
a rod configured for vertical insertion into a planting bed;
a positioner slidably couplable to said rod, wherein said positioner is slidably couplable to said rod between a top end and a bottom end of said rod, such that said positioner is positionable at a required height relative to a stem of a plant positioned proximate to said rod in the planting bed;
a holder coupled to said positioner, said holder comprising a strap, said strap being variably couplable to said holder to form a loop, wherein said strap is configured for positioning around the stem of the plant and coupling to said holder such that said loop extends from said holder around the stem of the plant to support the plant; and
wherein said rod is configured for vertical insertion into the planting bed proximate to the stem of the plant requiring support, wherein said positioner is variably couplable to said rod such that said positioner is positionable at a required height relative to the stem of the plant, and wherein said strap is configured for positioning around the stem of the plant and coupling to said holder such that said loop extends from said holder around the stem of the plant to support the plant.

2. The device of claim 1, further including said rod being circular when viewed longitudinally.

3. The device of claim 1, further including said rod comprising aluminum.

4. The device of claim 1, further including said rod comprising plastic.

5. The device of claim 1, further including said rod having a bottom end, said bottom end being pointed, wherein said bottom end is configured for insertion into the planting bed.

6. The device of claim 1, further including said positioner comprising:
a block; and
a channel positioned through said block proximate to a first end of said block, said channel being complementary to said rod.

7. The device of claim 6, further including said block being substantially rectangularly box shaped.

8. The device of claim 6, further including said block being resilient.

9. The device of claim 8, further including said block comprising rubber.

10. The device of claim 1, further including a gasket slidably couplable to said rod between said positioner and a bottom end of said rod, wherein said gasket is positioned on said rod to retain said positioner at the required height relative to the stem of the plant.

11. The device of claim 10, further including said gasket being resilient.

12. The device of claim 11, further including said gasket comprising rubber.

13. The device of claim 1, further including a coupler coupled to said block, said coupler being positioned on a side of said block proximate to a second end of said block, said coupler being couplable to said strap to form said loop.

14. The device of claim 13, further comprising:
said strap comprising a rack gear;
said coupler comprising a ratchet box; and
wherein said ratchet box is positioned to gearedly couple to said rack gear of said strap to form said loop.

15. The device of claim 1, further including said strap comprising nylon.

16. The device of claim 1, further including said strap comprising stainless steel.

17. A plant support device comprising:
a rod configured for vertical insertion into a planting bed, said rod being circular when viewed longitudinally, said rod comprising aluminum, said rod comprising plastic, said rod having a top end and a bottom end, said bottom end being pointed, wherein said bottom end is configured for insertion into the planting bed;
a positioner slidably couplable to said rod, wherein said positioner is slidably couplable to said rod between said top end and said bottom end such that said positioner is positionable at a required height relative to a stem of a plant positioned proximate to said rod in the planting bed, said positioner comprising:
a block, said block being substantially rectangularly box shaped, said block being resilient, said block comprising rubber, and
a channel positioned through said block proximate to a first end of said block, said channel being complementary to said rod;
a gasket slidably couplable to said rod between said positioner and said bottom end, wherein said gasket is positioned on said rod to retain said positioner at the required height relative to the stem of the plant, said gasket being resilient, said gasket comprising rubber;
a holder coupled to said positioner, said holder comprising a strap, said strap being variably couplable to said holder to form a loop, wherein said strap is configured for positioning around the stem of the plant and coupling to said holder such that said loop extends from said holder around the stem of the plant to support the plant, said strap comprising a rack gear, said strap comprising nylon, said strap comprising stainless steel;
a coupler coupled to said block, said coupler being positioned on a side of said block proximate to a second end of said block, said coupler being couplable to said strap to form said loop, said coupler comprising a ratchet box, wherein said ratchet box is positioned to gearedly couple to said rack gear of said strap to form said loop; and
wherein said rod is configured for vertical insertion into the planting bed proximate to the stem of the plant requiring support, wherein said positioner is variably couplable to said rod such that said positioner is positionable at a required height relative to the stem of the plant, and wherein said strap is configured for positioning around the stem of the plant and coupling to said holder such that said loop extends from said holder around the stem of the plant to support the plant.
